(19) United States
(12) Patent Application Publication
(10) Pub. No.: US 2024/0227580 A1
(43) Pub. Date: Jul. 11, 2024

(54) MOTOR ELECTRICAL POWER CONSUMPTION BASED MOBILE VEHICLE CARBON EMISSION COMPUTATION METHOD

(71) Applicant: LI-HO YAO, Taipei City (TW)

(72) Inventor: LI-HO YAO, Taipei City (TW)

(21) Appl. No.: 18/396,738

(22) Filed: Dec. 27, 2023

(30) Foreign Application Priority Data
Jan. 9, 2023 (TW) 112100816

(51) Int. Cl. B60L 15/20; G06Q 30/018

(52) U.S. Cl. CPC B60L 15/2045; G06Q 30/018; B60L 2240/547; B60L 2240/549; B60L 2240/622; B60L 2240/70

(57) ABSTRACT

High frequency reading of position information and high frequency measuring of voltage and current inputted through a control module into a motor are adopted for calculation of unit electrical power consumption. Multiple unit electrical power consumptions are summed up to form a summed electrical power consumption. All summed electrical power consumption of a journey, and corresponding position information, are uploaded to the cloud for conversion into carbon emissions of the round of journey. The high frequency measurement and the summing-up operation make it possible to greatly increase the accuracy of consumption of electrical power of a mobile vehicle in a journey, without causing faulty estimation of the carbon emission of each round of journey. Peripheral computation technology is adopted for reducing bandwidth loading for uploading to the cloud and increasing the uploading speed to further reduce the loading of the cloud server for operation, storage, and processing data.

### BACKGROUND OF THE INVENTION

### (a) Technical Field of the Invention

The present invention belongs to the technical field of computation of mobile vehicle carbon emission.

### (b) Description of the Prior Art

Heretofore, carbon emission of an electrical vehicle is calculated on the basis of consumption of electrical energy of an electrical battery during a journey. Methods that are commonly adopted for measuring electrical power of an electrical battery mainly include (1) externally measuring the voltage of a battery set; and (2) applying a battery management system inside a battery set to measure the voltage. However, when the loading is suddenly increased (output current being increased), the voltage of the battery drops down, so that there may be faults if the voltage is used solely in determining the residual power. Further, during a period of use, the battery is repeatedly charged and discharged, and consequently, the battery pack becomes deteriorating, resulting in an increase of internal resistance, and this also causes faults in the determination of electrical power. To alleviate the problem of battery pack deterioration, lithium-iron battery packs that are capable of being charged and discharged for more times have been widely used. However, the characteristics of the lithium-iron battery are such that the voltage variation is relatively small during the processes of charging and discharging, and this similarly results in difficulty of accurately estimating the residual electrical power of the battery.

In other words, when the residual power of a battery is mistakenly estimated, calculation of the electrical power of the battery that has been consumption is also incorrect, and this results in mistaken calculation of the carbon emission of an electrical vehicle during each journey thereof. Further, the calculation of the carbon emission that is implemented currently is constrained by transmission bandwidth and speed, and server capacity and the calculation of carbon emission of a journey of the electrical vehicle can only be computed by taking the distance of the journey and the residual capacities of power at starting and ending of the journey as a calculation basis. This leaves room for counterfeiting and cheating, and consequently, the carbon emission cannot be truly and correctly computed. The invention is made to overcome the above problems.

### SUMMARY OF THE INVENTION

The primary objective of the present invention is to use technology of high frequency measurement, peripheral computation, and summing operation to greatly increase calculation accuracy of carbon emission for each journey, so as to allow all the people to well use of green mobile vehicles, to effectively engage in trading of carbon credit, and also to create sharing economics for carbon credit market.

Another objective of the present invention is to adopt a means of high frequency measurement to inspect, according to whether current and voltage applied by a control module into a motor correspond to variation and change of position information, a true situation of use, in order to reduce events of counterfeiting and cheating for carbon emission to truly achieve the purposes of reducing greenhouse gases.

A further objective of the present invention is to use peripheral computation technology to reduce bandwidth loading for uploading to cloud and to increase the uploading speed to further reduce the loading of operation, storage, and processing of the cloud server.

### BRIEF DESCRIPTION OF THE DRAWINGS

FIG. 1 is a schematic view showing system architecture of a preferred embodiment of the present invention.

FIG. 2 is a schematic view showing system architecture of another preferred embodiment of the present invention.

FIG. 3 is a schematic view showing a flow of a method according to the present invention.

FIG. 4 is a schematic view showing application architecture of actual implementation of the present invention.

FIG. 5 is a schematic view showing an application flow of actual implementation of the present invention.

### DETAILED DESCRIPTION OF THE PREFERRED EMBODIMENTS

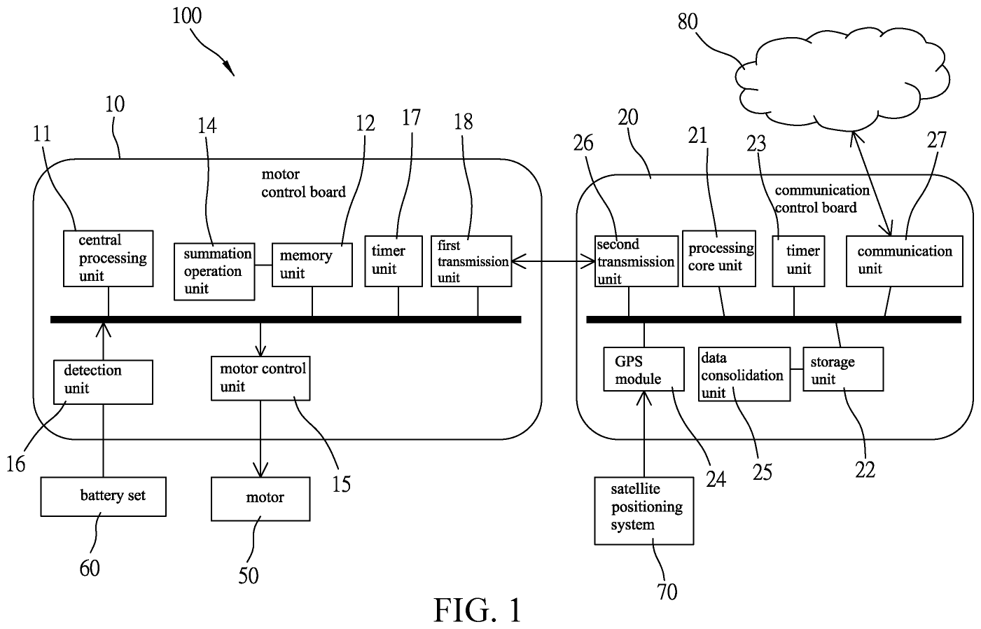

As shown in FIG. 1, the present invention is applicable to a control module 100 that is operable to control a motor 50 and a battery set 60 of a mobile vehicle. The control module 100 comprises a motor control board 10 and a communication control board 20. The motor control board 10 includes a central processing unit 11, and a memory unit 12, a motor control unit 15, at least one detection unit 16, a timer unit 17, and a first transmission unit 18 connected with the central processing unit 11, wherein the central processing unit 11 is configured for executing and processing various programs, data, and instructions, and the memory unit 12 is configured for storing programs, consumed electrical energy [referring to as electrical power consumption hereinafter] calculation formulas, measurement data, and summation calculation result data, and also, the memory unit 12 further comprises a summation operation unit 14 that is configured for summing up multiple electrical power consumption calculation results of a same journey, and further, the motor control unit 15 is configured for connecting with an external motor 50 to operate and control operation of the motor 50, and further, the detection units 16 are connected to the battery set 60 that is arranged externally for supplying electrical power to the control module 100 to measure input current and voltage that the battery set 60 applies through the control module 100 to drive the motor 50, and further, the timer unit 17 is configured for setting a frequency at which the detection units 16 are operated and controlled to measure voltage and current input from the battery set 60 for calculation of the electrical power consumption, and further, the first transmission unit 18 is configured for mutual data transmission of the motor control board 10 and the communication control board 20, and according to some embodiments, the central processing unit 11, the memory unit 12, the motor control unit 15, the timer unit 17, and/or the first transmission unit 18 are an integrated semiconductor device.

The communication control board 20 includes a processing core unit 21, and a storage unit 22, a timer unit 23, a GPS module 24, a second transmission unit 26, and a communication unit 27 connected with the processing core unit 21, wherein the processing core unit 21 is configured for executing and processing various programs, data, and instructions, and the storage unit 22 is configured for storing programs and various sorts of data, and also, the storage unit 22 further comprises a data consolidation unit 25 that consolidates a summation result of electrical power consumption of a same journey, and journey position and distance, and further, the GPS module 24 is configured for connecting with at least one external positioning satellite system 70 to read journey position and distance, and further, the second transmission unit 26 is configured for connecting with the first transmission unit 18 of the motor control board 10 for mutual data transmission, and the communication unit 27 is configured for connecting, through a network, with an external cloud server 80 for data uploading, and further, the timer unit 23 is configured for setting a frequency at which the GPS module 24 is operated to read the journey position and distance and the communication unit 27 is operated for data uploading, and further, according to some embodiments, the processing core unit 21, the storage unit 22, the timer unit 23, the second transmission unit 26, and/or the communication unit 27 are an integrated semiconductor device.

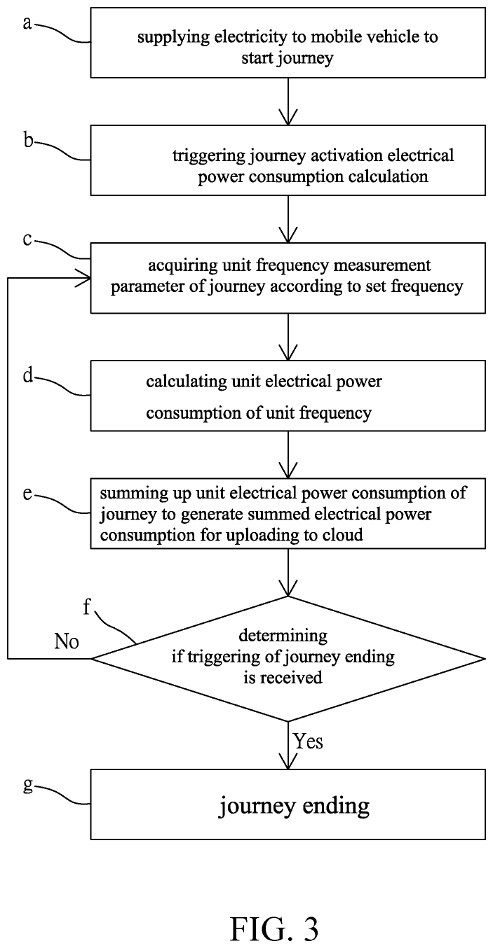

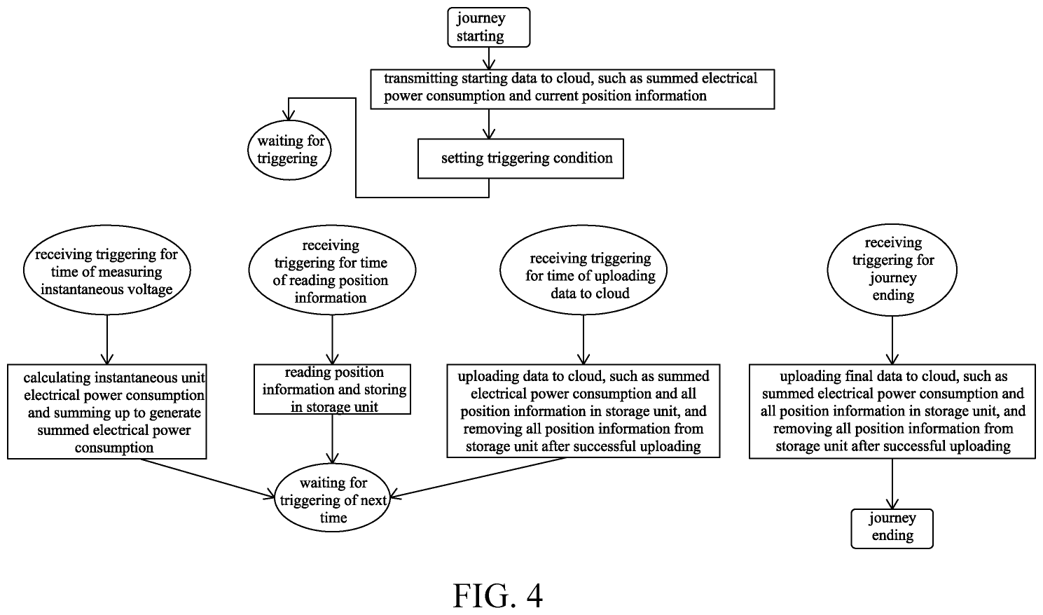

In practical application of the present invention, as shown in FIGS. 1, 3, and 4, the control module 100 is used to calculate, by means of peripheral technology through high frequency measurement, the electrical power consumption of the battery set 60 for driving the motor 50 in a same journey of a mobile vehicle, and summing up a total of the journey to generate a journey electrical power consumption, and uploading journey carbon emission converted from the journey electrical power consumption for trade of carbon credit, and before the present invention is used, various settings for operation and control are made in advance in programs executed by the central processing unit 11 of the motor control board 10 and the processing core unit 21 of the communication control board 20 of the control module 100, at least including setting of triggering condition [the time of instantaneous voltage value of the battery set 60 supplying electricity to the control module 100 at activation, such as 0.1 seconds], setting of measurement frequency [time interval for each time measuring voltage and current, such as one measurement per every 0.1 seconds], and setting of reading frequency [time interval for each time reading position and distance, such as one reading per every 10 seconds] and setting of uploading time [time interval for each time uploading data, such as one uploading per every 60 second], and the steps of a flow of a motor electrical power consumption based mobile vehicle carbon emission computation method according to the present invention are as follows:
(a) supplying electricity to mobile vehicle to start journey: when a mobile vehicle is prepared for executing a journey, electrical power of the mobile vehicle is first activated, and the communication unit 27 of the communication control board 20 starts executing transmission of journey starting data of the mobile vehicle stored in the memory unit 12 and the storage unit 22 of the motor control board 10 and the communication control board 20 to the cloud, including, but not limited to, summed electrical power consumption and position information, and waiting for a user to externally trigger the motor 50 to drive the mobile vehicle to execute Step (b);
(b) triggering journey activation electrical power consumption calculation: when the user triggers the motor 50 to drive the mobile vehicle after electricity is supplied to the mobile vehicle, an input current of the battery set 60 is applied through the control module 100 to drive the motor 50, and when the detection units 16 of the motor control board 10 detect rise maintaining time of the instantaneous voltage of electrical power supplied from the battery set 60 to drive the motor 50 reaches a set value [0.1 seconds] of the timer unit 17, the system is internally triggered to execute Step (c), and the central processing unit 11 of the motor control board 10 uses electrical power consumption programs stored in the memory unit 12 to calculate the electrical power consumption externally triggering the motor 50, the electrical power consumption of externally triggering being defined as triggering electrical power consumption and stored in the memory unit 12;
(c) acquiring unit frequency measurement parameter of journey according to set frequency: when the mobile vehicle is triggered and driven, the communication control board 20 of the control module 100 uses the GPS module 24 to read, according to the set frequency of the timer unit 23 [such as every 10 seconds], position information of the mobile vehicle, and stores the position information of each unit frequency sequentially in the storage unit 22, and the detection units 16 of the motor control board 10 measure, according to the set frequency of the timer unit 17 [such as every 0.1 seconds], parameters of current and voltage inputted from the battery set 60 to the control module 100, and stores the parameters of current and voltage of each unit frequency sequentially in a buffer of the memory unit 12 for subsequent execution of Step (d);
(d) calculating unit electrical power consumption of unit frequency: after the acquisition of the measurement parameters of unit frequency, the electrical power consumption programs in the central processing unit 11 of the motor control board 10 calculate, according to the parameters of current and voltage, the electrical power consumption of the motor 50 for each unit frequency, and the electrical power consumption of the unit frequency is defined as unit electrical power consumption, and each unit electrical power consumption is stored sequentially in the memory unit 12 for subsequent execution of Step (e);
(e) summing up unit electrical power consumption of journey to generate summed electrical power consumption for uploading to cloud: after completion of calculation of multiple unit electrical power consumptions, according to set condition of uploading time, such as one uploading per every 60 seconds, a summation operation is applied to the unit electrical power consumptions that have been calculated but have not yet been summed up to generate a summed electrical power consumption, and the communication unit 27 of the communication control board 20 uploads the summed electrical power consumption and position information stored in the memory unit 12 and the storage unit 22 to a designated cloud server 80, and also removes the already-uploaded position information from the storage unit 22 after successful uploading, and executing Step (f);
(f) determining if triggering of journey ending is received: after completion of uploading of each summed electrical power consumption, a determination is made as to whether or not triggering of journey ending is received, and if the system does not receive ending of the journey, cyclically executing Step (c) to Step (e), otherwise when triggering of ending of the journey is received, executing Step (g); and
(g) journey ending: when the system receives triggering of journey ending, such as the battery set 60 of the mobile vehicle terminating input of current to the control module 100, the communication unit 27 of the communication control board 20 uploads final data in the memory unit 12 and the storage unit 22 of the motor control board 10 and the communication control board 20 to the designated cloud server 80, including, but not limited to, summed electrical power consumption and position information, and also, removes the already-uploaded position information from the storage unit 22 when the uploading is successful, and ends the journey, to allow the designated cloud server 80 to convert, through calculation, the triggering electrical power consumption, the multiple summed electrical power consumptions, and multiple pieces of position information of the journey of the mobile vehicle that are so uploaded into carbon emissions, and summing up to form a journey total carbon emission for subsequent operation of trading of carbon credit.

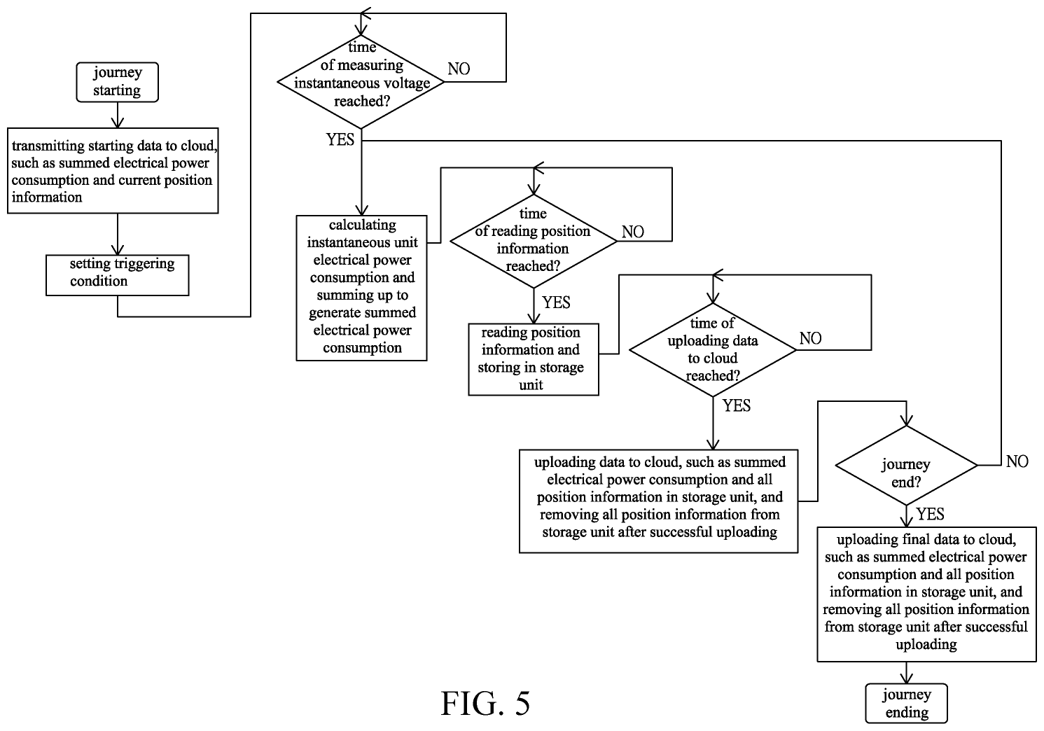

As shown in FIG. 5, which shows an operation flow of a preferred embodiment of the present invention, when the mobile vehicle starts a journey, the control module 100 transmits starting data to a designated cloud server 80, such as the summed electrical power consumption not removed from the memory unit 12 and current position information in the storage unit 22; and determines if time of instantaneous voltage inputted from the battery set 60 at the moment of triggering of activation of the motor 50 reaches a set value, and if not, continuing to wait for triggering, otherwise applying measurement of the instantaneous voltage and current to calculate the triggering electrical power consumption, and calculating the unit electrical power consumption of said unit frequency and sequentially summing up the unit electrical power consumptions to generated a summed electrical power consumption, and continuing to determine if time of reading position information is reached, and if not reaching the condition, then continuing to wait for the reading time of the next unit frequency, otherwise if the reading time of the unit frequency is reached, then reading position information for storing in the storage unit 22, and continuing to determine if time of uploading data to the cloud is reached, and if not, repeatedly executing executes determining time for measuring instantaneous voltage and current and reading position information is reached, otherwise if the uploading time is reached, then uploading data to the cloud, including, but not limited to, the summed electrical power consumption and position information, and removing the already-uploaded position information after successful uploading, and then continuing to determine if the journey ends, and if not yet ending the journey, then repeatedly executing determining time of measuring instantaneous voltage and current and reading position information and uploading data is reached, otherwise if ending journey is triggered, then uploading final data to the cloud, including, but not limited to, the triggering electrical power consumption, the summed electrical power consumption, and position information, and removing the already-uploaded position information after successful uploading, meanwhile ending the journey.

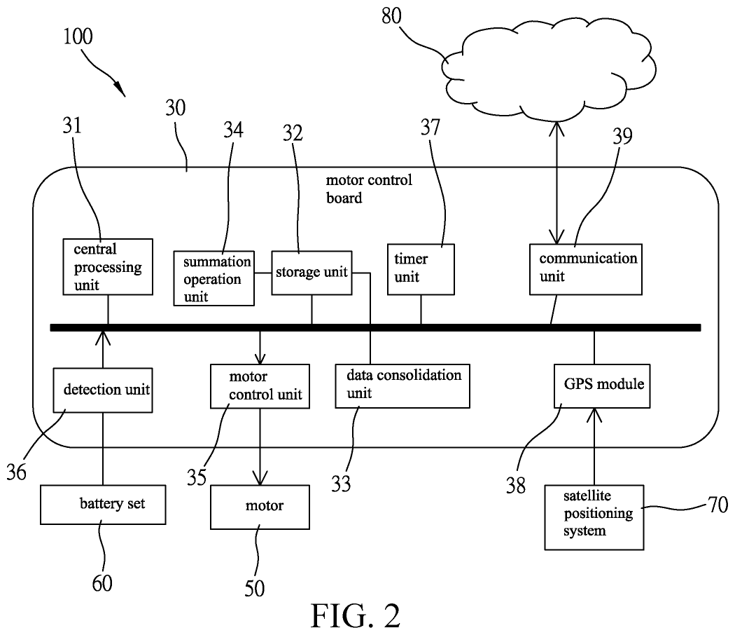

According to some embodiments, as shown in FIG. 2, the control module 100 is formed of a motor control board 30, and the motor control board 30 includes a central processing unit 31, and a storage unit 32, a motor control unit 35, at least one detection unit 36, a timer unit 37, a GPS module 38, and a communication unit 39 connected with the central processing unit 31, wherein the central processing unit 31 is configured for executing and processing various programs, data, and instructions, and the motor control unit 35 is configured for connecting with an external motor 50 to operate and control operation of the motor 50, and further, the detection units 36 are connected with the battery set 60 that is externally arranged for supplying electricity to the control module 100 to measure input current and voltage from the battery set 60 for driving the motor 50, and the storage unit 32 is configured for storing programs, electrical power consumption calculation formulas, measurement data and summation calculation result data, and also, the storage unit 32 further comprises a summation operation unit 34 that is configured for summing up multiple results of calculation of electrical power consumption of a same journey and a data consolidation unit 33 that is configured for consolidating the summed result of electrical power consumption of the journey, and the journey position and distance, and further, the GPS module 38 is configured for connecting with an external positioning satellite system 70 for reading journey position and distance, and further, the communication unit 39 is configured for connecting, through a network, with an external cloud server 80 for data uploading, and further, the timer unit 37 is configured for setting a frequency at which the detection units 36 are operated to measure input voltage and current of the battery set 60 for calculating electrical power consumption and a frequency at which the GPS module 38 reads the journey position and distance from the positioning satellite system 70, and a frequency at which the communication unit 39 uploads data, this being similarly applied to execute the carbon emission computation method of the present invention.

It can be appreciated from the above that the present invention uses the control module 100 to read, with high frequency, position information, and to calculate unit electrical power consumption through measurement, with high frequency, of voltage and current inputted from the battery set 60 to the control module 100, and to sum up the unit electrical power consumptions to form a summed electrical power consumption and subsequently uploading all the summed electrical power consumptions of a journey and corresponding position information to the cloud for conversion into carbon emission of the journey, and by means of high frequency measurement and summing-up operation, the accuracy of consumption of electrical power of the mobile vehicle is the journey can be increased, without causing faulty estimation of the carbon emission of each journey, and peripheral computation technology is adopted for reducing bandwidth loading for uploading to the cloud and increasing the uploading speed to further reduce the loading of the cloud server for operation, storage, and processing data, and by adopting a means of high frequency measurement to inspect whether current and voltage applied by the control module 100 into the motor 50 correspond to variation and change of position information, a true situation of use can be verified, in order to reduce room of counterfeiting and cheating, allowing the carbon emission of the mobile vehicle to be truly and correctly computed for applying to carbon credit trading of green mobile vehicles to allow the issue of greenhouse gas reduction to be truly resolved and to create and invigorate the green mobile vehicle industry.

I claim:

1. A motor electrical power consumption based mobile vehicle carbon emission computation method, which is applicable to a control module of a mobile vehicle that is operable to control a battery set to drive a motor, the control module at least comprising a central processing unit, and a storage unit, a motor control unit that controls the motor, at least one detection unit that detects a voltage and a current of the battery set, a timer unit, a GPS module that is connectable with at least one external positioning satellite system, and a communication unit that transmits data to at least one external cloud server, all in connection with the central processing unit, wherein the storage unit further comprises a summation operation unit and a data consolidation unit, steps of the carbon emission computation method comprising:
(a) supplying electricity to mobile vehicle to start journey: activating a power supply to prepare to execute a journey, and waiting for external triggering of the motor to drive a motion of the mobile vehicle, and then executing Step (b);
(b) triggering journey activation electrical power consumption calculation: after the external triggering of the motor, using the detection unit to detect if rise maintaining time of an instantaneous voltage of supplying electricity from the battery set to drive the motor reaches a set value of the timer unit, which is internal triggering, and executing Step (c), and also calculating electrical power consumption of the external triggering, the electrical power consumption of the external triggering being defined as triggering electrical power consumption and stored in the storage unit;
(c) acquiring unit frequency measurement parameter of journey according to set frequency: using the GPS module to read, according to a frequency set by the timer unit, position information of the mobile vehicle, and measuring, according to a set frequency, a current and a voltage inputted to the control module for subsequently executing Step (d);
(d) calculating unit electrical power consumption of unit frequency: calculating electrical power consumption of the motor for each unit frequency according to parameters of the previously acquired current and voltage, the electrical power consumption of said unit frequency being defined as unit electrical power consumption for subsequently executing Step (e);
(e) summing up unit electrical power consumption of journey to generate summed electrical power consumption for uploading to cloud: according to a set condition for uploading time, summing up unit electrical power consumptions that are already calculated but not summed up to generate a summed electrical power consumption, and uploading the summed electrical power consumption and the position information to a designated cloud server, and executing Step (f);
(f) determining if triggering of journey ending is received: determining whether or not triggering for journey ending is received, and Step (c) to Step (e) are cyclically executed if triggering of ending journey is not received, and otherwise, executing Step (g) if triggering of ending journey is received; and
(g) journey ending: uploading final data, including, but not limited to the summed electrical power consumption and the position information, to the designated cloud server when the triggering of journey ending is received, to allow the cloud server to convert the triggering electrical power consumption, the summed electrical power consumption, and the position information uploaded in the journey into carbon emissions for summing up to form a journey total carbon emission for subsequent carbon credit trading operations.

2. The motor electrical power consumption based mobile vehicle carbon emission computation method according to claim 1, wherein the set value of the timer unit for detecting the rise maintaining time of the instantaneous voltage for driving the motor in Step (b) of triggering journey activation electrical power consumption calculation is 0.1 seconds.

3. The motor electrical power consumption based mobile vehicle carbon emission computation method according to claim 1, wherein the frequency set by the timer unit for the GPS module in Step (c) of acquiring unit frequency measurement parameter of journey according to set frequency is to read the position information of the mobile vehicle one time for every 10 seconds.

4. The motor electrical power consumption based mobile vehicle carbon emission computation method according to claim 1, wherein the frequency set by the timer unit for the detection unit in Step (c) of acquiring unit frequency measurement parameter of journey according to set frequency is to measure information of current and voltage inputted into the control module from the battery set one time for every 0.1 seconds.

5. The motor electrical power consumption based mobile vehicle carbon emission computation method according to claim 1, wherein the uploading time in Step (e) of summing up unit electrical power consumption of journey to generate summed electrical power consumption for uploading to cloud is uploading one time every 60 seconds.

6. The motor electrical power consumption based mobile vehicle carbon emission computation method according to claim 1, wherein the control module comprises a motor control board and a communication control board, and the motor control board comprises a central processing unit, and a memory unit, a motor control unit operating and controlling the motor, at least one detection unit that detects the voltage and current of the battery set, a timer unit, and a first transmission unit, all connected with the central processing unit, wherein the memory unit further comprises a summation operation unit, and the communication control board comprises a processing core unit, and a storage unit, a timer unit, a GPS module that is connectable with at least one external positioning satellite system, a second transmission unit that is connectable with the first transmission unit, and a communication unit that transmits data to at least one external cloud server, all connected with the processing core unit, wherein the storage unit further comprises a data consolidation unit.
